(19) United States
(12) Patent Application Publication
(10) Pub. No.: US 2023/0382345 A1
(43) Pub. Date: Nov. 30, 2023

(54) Controlled Deployment of Structures

(71) Applicant: APPLE INC., Cupertino, CA (US)

(72) Inventors: Arturo Llamazares Domper, San Jose, CA (US); Yogesh Upreti, Riedstadt (DE); Martin Gross, Haimhausen (DE)

(21) Appl. No.: 18/134,136

(22) Filed: Apr. 13, 2023

Related U.S. Application Data
(60) Provisional application No. 63/345,467, filed on May 25, 2022.

(51) Int. Cl. B60R 21/36; B60R 21/0136

(52) U.S. Cl. CPC B60R 21/36; B60R 21/0136; B60R 2021/346

(57) ABSTRACT

A first object includes an internal support and an exterior portion coupled to the internal support. A prediction may be made that contact between the exterior portion and a second object will occur. A sensor is configured to output a force signal that indicates the contact between the exterior portion and the second object has occurred, and the controller is configured to take an action based on the prediction and the force signal.

### CROSS-REFERENCE TO RELATED APPLICATIONS

This application claims the benefit of U.S. Provisional Application No. 63/345,467, filed on May 25, 2022, the contents of which are hereby incorporated by reference in its entirety for all purposes.

### FIELD

The present disclosure relates generally to the field of deploying structures in a controlled manner.

### BACKGROUND

A first object may contact a second object. In some instances, a portion of the first object can be deployed in response to, or in advance of, the contact.

### SUMMARY

One aspect of the disclosure relates to a vehicle that includes an internal support and an exterior portion coupled to the internal support. A deployable portion is coupled to the exterior portion and includes a stored configuration and a deployed configuration. A sensor is configured to output a signal that indicates contact between the exterior portion and an object has occurred, and the contact between the exterior portion and the object is predicted prior to the contact. The deployable portion is configured to transition between the stored configuration and the deployed configuration based on the prediction and the signal.

Another aspect of the disclosure relates to a vehicle that includes an internal support and an exterior portion coupled to the internal support. A deployable portion is coupled to the exterior portion and includes a stored configuration and a deployed configuration. A controller configured to predict that contact between the exterior portion and an object will occur and to cause the deployable portion to transition between the stored configuration and the deployed configuration before the contact occurs.

Yet another aspect of the disclosure relates to a vehicle contact detection system comprising a first deployable portion and a second deployable portion coupled to an exterior portion of a vehicle. The first deployable portion and the second deployable portion are independently movable from a stored configuration to a deployed configuration. A controller is configured to select either the first deployable portion or the second deployable portion for deployment and to cause the selected one of the first deployable portion or the second deployable portion to deploy.

### BRIEF DESCRIPTION OF THE DRAWINGS

FIGS. 1A-B are illustrations of a side cross-sectional view and a top view, respectively, of a vehicle as the vehicle approaches an object.

FIG. 2 is a timing diagram indicating relative timing of actions of the vehicle of FIGS. 1A-B.

FIG. 3 is a side cross-sectional view of the vehicle of FIGS. 1A-B after the vehicle contacts the object.

FIGS. 4A-B are illustrations of the top view of the vehicle of FIGS. 1A-B after the vehicle contacts the object.

FIGS. 5-6 are illustrations another embodiment of the side cross-sectional view and the top view, respectively, of the vehicle of FIGS. 1-2 after the vehicle contacts the object.

FIG. 7 is a diagram of a controller.

FIG. 8 is an illustration of a process for the controller taking an action before or during contact.

### DETAILED DESCRIPTION

The disclosure herein relates to systems and methods for controlling deployment of portions of a vehicle in response to, or in advance of, contact with an object external to the vehicle. In some instances, controlling deployment of portions is based on the type of object with which the vehicle collides. For example, if the object is an object of interest (e.g., a human) then a controller in the vehicle may cause the portions to deploy. If the object is not an object of interest (e.g., an animal, a ball, trash, or any other non-human object), then the controller in the vehicle may not cause the portions to deploy.

Furthermore, before deploying one or more of the portions, the controller may predict a size of the object of interest (e.g., a large male, a small female, a child, etc.) and a contact area on the vehicle. A sensor on or in the vehicle may also output a force signal to the controller to indicate (e.g., confirm) that the contact between the object of interest and the vehicle has occurred. Based on the determinations and/or predictions and the force signal, the controller may selectively cause one or more of the portions to deploy. In instances where the portions can be reversibly deployed and retracted, the controller may selectively cause one or more of the portions to deploy prior to the contact.

By predicting that the vehicle will collide with an object of interest and the contact area, and then confirming contact via a force signal, the systems and methods described herein can reduce the time required to deploy structures when compared to conventional detection and deployment systems. For example, conventional systems may require at least ten milliseconds (“ms”) to determine that contact occurred and at least thirty-five ms to deploy structures after contact occurs (e.g., a total response time of at least forty-five ms). The systems and methods described herein can reduce the sensing time to zero ms.

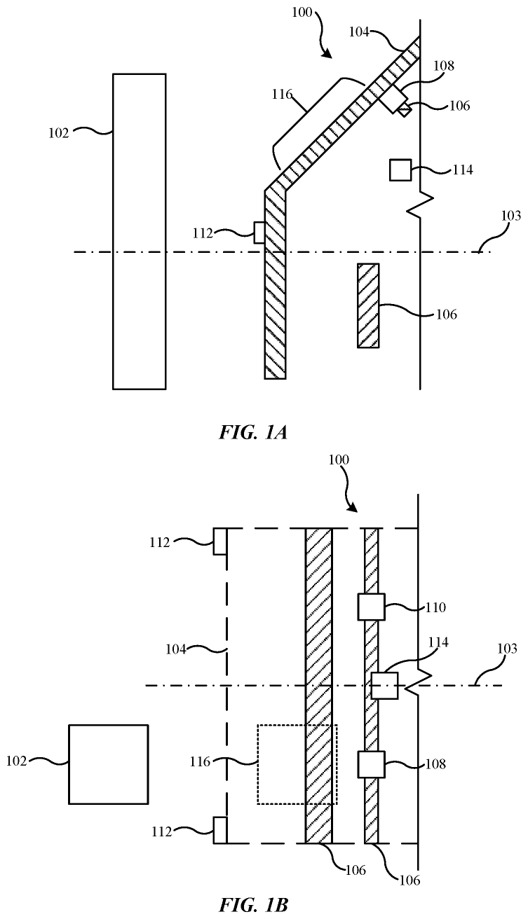

FIGS. 1A-B are illustrations of a side cross-sectional view and a top view, respectively, of a vehicle 100 as the vehicle 100 approaches an object 102. The vehicle 100 can be any type of vehicle including, but not limited to, gas or diesel-powered vehicles, electric vehicles, boats or other marine vehicles, aircraft (e.g., airplanes, helicopters, etc.), remote-controlled vehicles, etc.

The vehicle 100 includes an exterior portion 104. The exterior portion 104 is an outermost portion of the vehicle 100 and may be positioned in any location around the vehicle 100. For example, the exterior portion 104 may be a panel such as an exterior body panel of the vehicle 100. In some embodiments, the exterior portion 104 may be a front portion and/or bumper. The exterior portion 104 may also be a rear portion and/or bumper and/or extend around one or more sides of the vehicle 100. The exterior portion 104 is configured to define and at least partially enclose various operational systems of the vehicle 100. For example, the exterior portion 104 may define and at least partially enclose support structures, engine components, battery components, suspension components, heating and cooling components, etc., of the vehicle 100.

As shown, the vehicle 100 also includes internal supports 106, a first deployable portion 108, a second deployable portion 110, a sensor 112, and a controller 114. To show these structures from the top view, the exterior portion 104 is shown as transparent in FIG. 1B for purposes of explanation only. The internal supports 106 are part of the structure of the vehicle 100. Generally, the internal supports 106 may be any member configured to provide support to the vehicle 100 (e.g., torsional support, weight-bearing support, etc.) as part of the structure of the vehicle 100. In some embodiments, the exterior portion 104 is coupled to the internal supports 106 and the internal supports 106 support the exterior portion 104. In some implementations, the internal supports 106 support additional components. For example, as shown in FIGS. 1A-B, the internal supports 106 may also support and/or be coupled to the first deployable portion 108 and the second deployable portion 110. The internal supports 106 may be configured in various orientations with respect to the vehicle 100 that can provide support. As shown in FIG. 1A, the internal supports 106 extend across a longitudinal axis 103 of the vehicle 100. The internal supports 106 may also be oriented along the longitudinal axis 103 of the vehicle 100 or in a generally vertical orientation (e.g., a vertical structural member). Other configurations in addition to those described may be implemented.

The first deployable portion 108 and the second deployable portion 110 are coupled to the exterior portion 104, include a stored configuration and a deployed configuration, and are configured to transition between the stored configuration and the deployed configuration. In some implementations, the first deployable portion 108 and the second deployable portion 110 are configured to transition between the stored configuration and the deployed configuration simultaneously. For example, the first deployable portion 108 and the second deployable portion 110 may have separate deployment mechanisms that are independently operable. In some implementations, the deployment mechanisms may be operated simultaneously to deploy the first deployment portion 108 and the second deployment portion 110 simultaneously. The first deployable portion 108 and the second deployable portion 110 may also have one deployment mechanism configured to operate both the first deployable portion 108 and the second deployable portion 110 simultaneously. Thus, operation of the deployment mechanism may simultaneously deploy the first deployable portion 108 and the second deployable portion 110.

The deployment mechanisms may also be operated asynchronously to deploy the first deployment portion 108 and the second deployment portion 110 at separate times. For example, the separate deployment mechanisms for the first deployable portion 108 and the second deployable portion 110 may be operated asynchronously to deploy the first deployable portion 108 and the second deployable portion 110 at separate times. More specifically, the first deployable portion 108 may transition between the stored configuration and the deployed configuration while the second deployable portion 110 remains in the stored configuration, and vice versa. An example arrangement of the first deployable portion 108 and the second deployable portion 110 is shown in FIGS. 1A-B. However, various other arrangements may be used. For example, the relative placement of the first deployable portion 108 and the second deployable portion 110 may be altered. Examples of altering the relative placements includes moving the first deployable portion 108 and the second deployable portion 110 closer together (e.g. toward the longitudinal axis 103 of the vehicle 100), moving the first deployable portion 108 and the second deployable portion 110 further apart (e.g. toward the exterior portion 104), changing the orientation of the first deployable portion 108 and the second deployable portion 110 (e.g., orienting the first deployable portion 108 and the second deployable portion 110 along the longitudinal axis 103 of the vehicle 100 instead of across the longitudinal axis 103 as shown in FIG. 1B). In addition, more assemblies may be used than those shown in FIGS. 1A-B. For example, two additional assemblies may be used so that each of the four assemblies (e.g., the first deployable portion 108, the second deployable portion 110, and the additional assemblies) is coupled to a quadrant of the exterior portion 104. Additional embodiments that implement more or fewer assemblies may also be used.

In some embodiments, the first deployable portion 108 and the second deployable portion 110 include an inflatable portion. In the stored configuration, the inflatable portion is not inflated (e.g., deflated), and in the deployed configuration, the inflatable portion is inflated. The inflatable portion may be configured to hold a pressurized fluid in the deployed configuration. The pressurized fluid may be a gas such as air, nitrogen, oxygen, etc. The pressurized fluid may also be a liquid such as water, oil, etc. In some implementations, the inflatable portion is an airbag that is inflated using a pyrotechnic actuator. As an example, a pyrotechnic actuator may operate by igniting sodium azide to generate pressurized nitrogen gas that deploys the airbag. The first deployable portion 108 and the second deployable portion 110 may also include a reversible inflatable portion such that, after the first deployable portion 108 and the second deployable portion 110 are deployed (e.g., inflated), the first deployable portion 108 and the second deployable portion 110 can be stored again by deflating the first deployable portion 108 and the second deployable portion 110. For example, the first deployable portion 108 and the second deployable portion 110 may include a valve that allows the pressurized fluid to be released, and an actuator may cause the first deployable portion 108 and the second deployable portion 110 to return to the stored configuration.

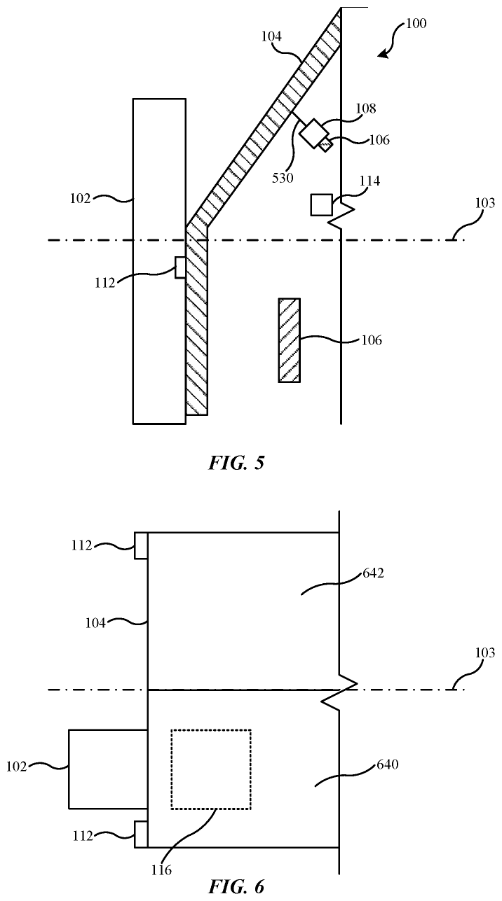

The first deployable portion 108 and the second deployable portion 110 may also include an extendable portion. In the stored configuration, the extendable portion is not extended, and in the deployed configuration, the extendable portion is extended. In some implementations, the extendable portion may include a linkage of rigid portions (e.g., bars, rods, etc.) where, in the stored configuration, the rigid portions are folded and, in the deployed configuration, the rigid portions are unfolded. The extendable portion may also include a hydraulic portion such as a piston/cylinder arrangement where, in the stored configuration, the piston is recessed into the cylinder and, in the deployed configuration, the piston is fully extended. Additional extendable portions may be implemented. The first deployable portion 108 and the second deployable portion 110 may include a reversible extendable portion such that, after the first deployable portion 108 and the second deployable portion 110 are deployed (e.g., extended), the first deployable portion 108 and the second deployable portion 110 can be stored again (e.g., by folding the portions and/or operating the hydraulic fluid to cause the piston to move to the recessed position). The extendable portion is further described with reference to FIGS. 5-6.

The sensor 112 is coupled to the vehicle 100 and is configured to provide signals to the controller 114 that indicate various characteristics. For example, the sensor 112 is configured to provide signals to the controller 114 that indicate a distance between the object 102 and the exterior portion 104. The sensor 112 may also be configured to provide signals to the controller 114 that indicate a size and/or shape and/or height of the object 102. The sensor 112 may also be configured to provide signals to the controller 114 that indicate a contact area located on the exterior portion 104. Accordingly, the sensor 112 can include one or more of an ultrasonic sensor, an infrared sensor, a light detection and ranging (“LiDAR”) sensor, a time-of-flight sensor, a photoelectric sensor, a displacement sensor, a visible light camera, an infrared camera, or any other type of sensor configured to generate a signal based on a distance between two objects, a size of an object, a shape of an object, etc. The sensor 112 is therefore configured to output a signal that indicates of a height of the object.

The sensor 112 may also be configured to provide signals to the controller 114 that indicate contact between the exterior portion 104 and the object 102 has occurred. Accordingly, the sensor 112 can include one or more of a force transducer, an accelerometer, or any other type of sensor that can provide a signal that indicates a change of motion (e.g., due to contact). The sensor 112 is therefore configured to output a force signal that indicates contact between the exterior portion 104 and the object 102 has occurred. Though two of the sensor 112 are shown in FIGS. 1A-B, any number of the sensor 112 can be used in various implementations and in various locations on or in the vehicle 100.

The controller 114 is coupled to or in communication with the vehicle 100, is in communication with the sensor 112, and may also be in communication with the first deployable portion 108 and the second deployable portion 110 and one or more actuators (not shown) that may be coupled to the first deployable portion 108 and the second deployable portion 110. In some implementations, the controller 114 may be a microcontroller or a processor for a computer coupled with the vehicle 100. The controller 114 may also be an external computer or a cloud-based computer. The controller 114 is configured to receive one or more signals from the sensor 112 and make a determination and/or a prediction based on the one or more signals. In an example embodiment, the controller 114 is configured to predict that contact between the exterior portion 104 and the object 102 will occur. The prediction may be based on the signal from the sensor 112 related to the distance between the exterior portion 104 and the object 102. For example, the controller 114 may receive signals from the sensor 112 that indicate the distance between the object 102 and the exterior portion 104 is decreasing. The controller 114 may also determine, based on the speed of the vehicle 100 and a relative position of the object 102, a threshold distance under which contact between the exterior portion 104 and the object 102 is unavoidable (e.g., if the threshold distance is less than a stopping distance or a distance over which the vehicle 100 is able to slow to a threshold speed). In another example embodiment, the controller 114 is configured to determine, based on signals received from the sensor 112, a height of the object 102 and or a contact area located on the exterior portion 104.

The controller 114 may also be configured to determine whether the object 102 is an object of interest prior to the contact. For example, an object of interest may be a first object or a second object that is within a threshold proximity to the vehicle 100 and is within a threshold size. The first object and the second object may be objects exterior to the vehicle 100. The first object may be, for example, a first human, and the second object may be, for example, a non-human. More specifically, the second object may be an animal, a road hazard (e.g., debris on the road, etc.), and/or a surface feature (e.g., a pothole, a bump, etc.). In some implementations, the second object may be a second human, and the controller 114 may be configured to distinguish between the first human and the second human (e.g., based on characteristics such as height, weight, body shape, location relative to the vehicle 100, etc.). For example, the controller 114 may be configured to determine that the first human is an object of interest (e.g., the first human may be in the path of the vehicle 100) and the second human is not an object of interest (e.g., the second human may not be in the path of the vehicle 100). To determine whether the object 102 is an object of interest, the controller 114 evaluates signals received from the sensor 112 using a trained machine learning model that has been trained to analyze characteristics of objects and determine whether they are objects of interest. For example, the characteristics may be image based (e.g., physical characteristics such as size, shape, weight distribution, etc.). The characteristics may also be thermal based (e.g., a heat signature such as a body temperature, etc.). Other characteristics of objects may also be analyzed. The trained machine learning model may include a trained neural network. Training the machine learning model may be accomplished, for example, by providing characteristics of various objects of interest to the controller 114, where the images of the objects of interest are tagged with specific characteristics (e.g., height, weight, shape, temperature, etc.) represented by the images. The machine learning model can then be tested by challenging the model to categorize additional images of objects of interest that are untagged. Upon categorizing the image, the machine learning model is notified whether the determined category (e.g., “object of interest” or “not object of interest”) is correct or incorrect, and the machine learning model updates internal image evaluation algorithms accordingly. Using this method, the machine learning model learns how to accurately categorize objects of interest and non-objects of interest based on images and/or other signals received from the sensor 112. Thus, determining whether the object 102 is an object of interest may be performed using the trained neural network, which receives images and/or heat signatures as an input.

If the controller 114 determines that the object 102 is an object of interest, the controller 114 may be further configured to determine the size and/or shape of the object 102. Determining the size and/or shape of the object 102 may include determining a height of the object 102. Furthermore, the controller 114 may be configured to determine a contact area based on the height of the object 102 and a location of the object 102 relative to the exterior portion 104. For example, FIGS. 1A-B indicate a contact area 116 located on the exterior portion 104 where a portion of the object 102 may contact a portion of exterior portion 104 when the exterior portion 104 contacts the object 102. In some embodiments, the contact area 116 is a secondary contact area. For example, the exterior portion 104 may initially contact the object 102 at a primary contact area (e.g., a portion of the exterior portion 104 located closer to a road surface than the contact area 116), and the force associated with the initial contact may cause the object 102 to move relative to the exterior portion 104 to cause the object 102 to contact the exterior portion 104 at the contact area 116. Thus, predicting that the contact between the exterior portion 104 and the object 102 will occur includes determining a height of the object 102 and predicting the contact area 116 located on the exterior portion 104.

The controller 114 is further configured to take an action based on one or more of the prediction of contact between the exterior portion 104 and the object 102, the force signal, the height of the object 102, and the contact area 116. For example, the action taken by the controller 114 may include causing the first deployable portion 108 and/or the second deployable portion 110 to transition between the stored configuration and the deployed configuration either before or after the contact occurs. In some implementations, the action taken by the controller 114 may include causing an inflatable portion to inflate based on one or more of the prediction of contact, the force signal, the height of the object 102, and the contact area 116. The action taken by the controller 114 may also include causing an extendable portion to extend based on one or more of the prediction of contact, the force signal, the height of the object 102, and the contact area 116. In implementations where the first deployable portion 108 and the second deployable portion 110 are independently movable from the stored configuration to the deployed configuration, the action taken by the controller 114 may include selecting either the first deployable portion 108 or the second deployable portion 110 for deployment and causing the selected one of the first deployable portion 108 or the second deployable portion 110 to transition between the stored configuration and the deployed configuration. In an example implementation, after determining that the object 102 is an object of interest prior to the contact, the controller 114 is configured to take the action when the force signal indicates that the contact has occurred. Accordingly, the action can be taken without any additional confirmation by the controller 114 after the contact occurs. As described above, predicting contact with the object of interest, and then confirming contact based on the force signal can reduce the total response time required to deploy the first deployable portion 108 and/or the second deployable portion 110 when compared to conventional detection and deployment systems. In some implementations, the systems and methods described herein can reduce the sensing time to zero ms.

Additionally, because the controller 114 determines the object 102 is an object of interest prior to contact, the controller 114 may take the action either prior to contact with the object 102 or after contact with the object 102. The controller 114 may determine whether to deploy one or both of the first deployable portion 108 and the second deployable portion 110 based on the contact area 116. For example, the contact area 116 as shown in FIG. 1A corresponds to the first deployable portion 108. Accordingly, the controller 114 may cause the first deployable portion 108 be selectively deployed (e.g., to transition between the stored configuration and the deployed configuration) based on the contact area 116. Thus, either the first deployable portion 108 or the second deployable portion 110 is configured to transition between the stored configuration and the deployed configuration based on the contact area 116, and moving from the stored configuration to the deployed configuration may occur before or after the exterior portion 104 contacts the object 102.

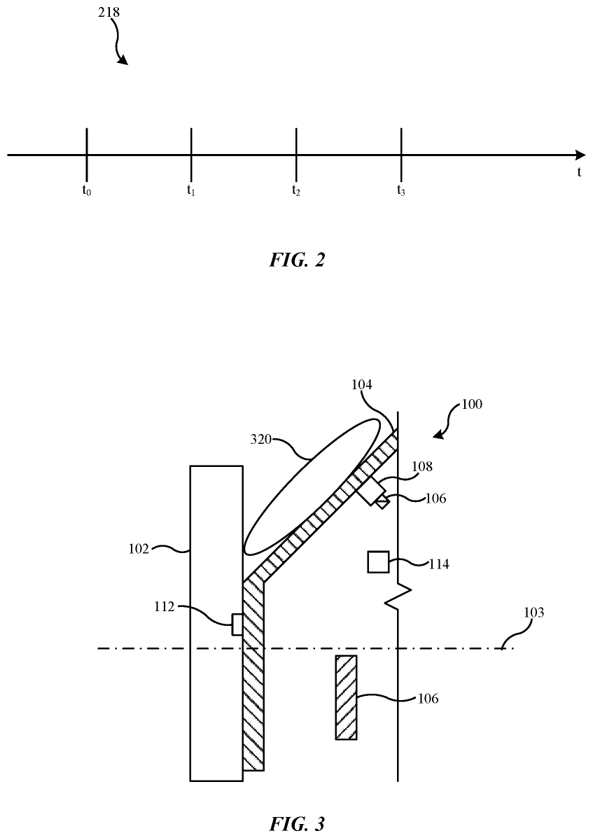

With reference to FIG. 2, a timing diagram 218 shows an example implementation of the relative timing of the actions described. At t₀, the controller 114 may predict, based on a signal from the sensor 112, that contact between the vehicle 100 and the object 102 will occur. For example, the vehicle 100 may be approaching an object of interest. In some implementations, the controller 114 may predict, based on relative speeds of the vehicle 100 and the object of interest, when the contact between the vehicle 100 and the object of interest will occur. For example, the controller 114 may predict the contact between the vehicle 100 and the object of interest will occur at t₂. In some implementations, the controller 114 may also predict the contact area 116. Based on the predictions, the controller 114 may determine whether to cause the first deployable portion 108, the second deployable portion 110, or both, to transition between the stored configuration and the deployed configuration. In an example implementation, the controller 114 may determine to cause the first deployable portion 108 to transition between the stored configuration and the deployed configuration.

In some implementations, the controller 114 may cause the first deployable portion 108 to transition between the stored configuration and the deployed configuration prior to the predicted contact between the vehicle 100 and the object of interest. For example, the controller 114 may cause the first deployable portion 108 to transition between the stored configuration and the deployed configuration at t₁ (e.g., prior to the predicted contact time of t₂).

The controller 114 may also cause the first deployable portion 108 to transition between the stored configuration and the deployed configuration after the predicted contact between the vehicle 100 and the object of interest (e.g., at time t₃). For example, the controller 114 may receive a signal from the sensor 112 confirming the contact between the vehicle 100 and the object of interest, and the controller 114 may cause the first deployment portion 108 to transition between the stored configuration and the deployed configuration within a threshold time after receiving the signal from the sensor 112. More specifically, it may take a certain amount of time for the first deployment structure 108 to transition between the stored configuration and the deployed configuration (e.g., a deployment duration). The controller 114 may also predict an amount of time between when contact between the vehicle 100 and the object of interest occurs and when contact between the object of interest and the contact area 116 occurs (e.g., a time to contact). In some implementations, the threshold time may be the difference between the contact duration and the deployment duration. If the threshold time is positive (e.g., the time to contact is greater than the deployment duration), the controller may cause the first deployment portion 108 to transition between the stored configuration and the deployed configuration after contact between the vehicle 100 and the object of interest occurs (e.g., at time t₃).

In some implementations, the controller 114 is configured to cause the first deployment portion 108 to transition between the stored configuration and the deployed configuration when the controller 114 receives the signal from the sensor 112 confirming contact between the vehicle 100 and the object of interest (e.g., at time t₂). For example, the amount of time between the sensor 112 confirming contact between the vehicle 100 and the object of interest and the controller 114 causing the first deployment portion 108 to transition from the stored configuration to the deployed configuration may be between zero and five milliseconds. Operating as described above, the first deployment portion 108 is configured to be in the deployed configuration when the object of interest contacts the contact area 116.

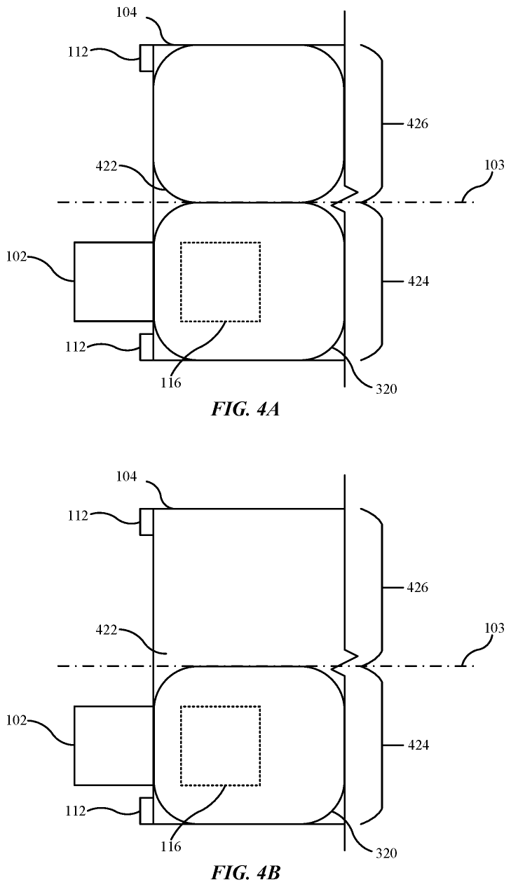

FIG. 3 is an illustration of the side cross-sectional view of the vehicle 100 of FIGS. 1A-B after the vehicle 100 contacts the object 102. FIGS. 4A-B are illustrations of the top view of the vehicle 100 of FIGS. 1A-B after the vehicle 100 contacts the object. A first inflatable portion 320 and a second inflatable portion 422 are shown in their deployed configurations in FIGS. 3 and 4A. The first inflatable portion 320 is shown in the deployed configuration and the second inflatable portion 422 is shown in the stored configuration in FIG. 4B. The first inflatable portion 320 may be deployed from the first deployable portion 108 and the second inflatable portion 422 may be deployed from the second deployable portion 110. In some implementations, the exterior portion 104 includes areas through which the first inflatable portion 320 and the second inflatable portion 422 move to reach an outer surface of the exterior portion 104. The areas may include a weakened portion (e.g., relative to the remaining portions of the exterior portion 104) configured to open as the first inflatable portion 320 and the second inflatable portion 422 inflate to allow the first inflatable portion 320 and the second inflatable portion 422 to go through the exterior portion 104 and cover a first portion 424 and a second portion 426, respectively, of the exterior portion 104. The areas may also include a space between the exterior portion 104 and another panel of the vehicle 100 through which the first inflatable portion 320 and the second inflatable portion 422 fit so they can inflate and cover the first portion 424 and the second portion 426, respectively.

The first inflatable portion 320 is configured to cover the first portion 424 of the exterior portion 104 when in the deployed configuration and the second inflatable portion 422 is configured to cover the second portion 426 of the exterior portion 104 when in the deployed configuration. As shown, the first portion 424 includes the contact area 116. The first portion 424 and the second portion 426 are shown as approximately equal in size, however the first portion 424 and the second portion 426 may also be different sizes. Accordingly, the first inflatable portion 320 and the second inflatable portion 422 may also be different sizes to approximately match the sizes of the first portion 424 and the second portion 426, respectively.

The first inflatable portion 320 and the second inflatable portion 422 may be independently operable by the controller 114. Therefore, the controller 114 may cause either the first inflatable portion 320 or the second inflatable portion 422 to transition between the stored configuration and the deployed (e.g., inflated) configuration based on, for example, the contact area 116. For example, because the first portion 424 includes the contact area 116, the controller 114 may cause the first inflatable portion 320 to inflate to transition between the stored configuration and the deployed configuration, where the first inflatable portion 320 covers the first portion 424. The controller 114 may leave the second portion 426 uncovered by not causing the second inflatable portion 422 to inflate (as shown in FIG. 4B). Thus, in the deployed configuration the first inflatable portion 320 covers a portion of the exterior portion 104 that includes the contact area 116 and leaves a remainder of the exterior portion 104 uncovered.

As described, the first inflatable portion 320 and the second inflatable portion 422 may be reversible (e.g., configured to inflate and deflate). Accordingly, the controller 114 may also cause the first inflatable portion 320 and the second inflatable portion 422 to deflate to transition between the deployed configuration and the stored configuration.

FIGS. 5-6 are illustrations of another embodiment of the side cross-sectional view and the top view, respectively, of the vehicle 100 of FIGS. 1A-B after the vehicle 100 contacts the object 102. A first extendable portion 530 is shown in its deployed configuration and may be deployed from the first deployable portion 108. A second extendable portion (not shown) may be deployed from the second deployable portion 110. Though the description below is focused on the first extendable portion 530, the description also applies to the second extendable portion and any additional extendable portions that may be implemented. The first extendable portion 530 may be deployed from the first deployable portion 108 and the second extendable portion may be deployed from the second deployable portion 110. The first extendable portion 530 is coupled to the exterior portion 104 and may be any type of structure or device configured to move a portion of the exterior portion 104 from a first position to a second position. For example, the first extendable portion 530 may include multiple rods (e.g., metal rods, polymer rods, composite rods, etc.) linked together such that the rods are configured to move relative to each other (e.g., rotate, slide, etc.) to transition between the stored configuration and the deployed configuration. The first extendable portion 530 may also include a telescoping structure (e.g., multiple tubes nested within each other in the stored configuration that are configured to extend relative to each other in the deployed configuration). Other types of extendable portions may be implemented.

The first deployable portion 108 and/or the first extendable portion 530 may include one or more actuators that are configured to cause the first extendable portion 530 to transition between the stored configuration and the deployed configuration. The controller 114 may be configured to operate the one or more actuators to cause the first extendable portion 530 to extend to transition between the stored configuration and the deployed configuration. Operation of first extendable portion 530 may be reversible such that the first extendable portion 530 is configured to reversibly move between the deployed configuration and the stored configuration. Thus, the first extendable portion 530 may be retracted to transition between the deployed configuration and the stored configuration. Accordingly, the controller 114 may also be configured to operate the one or more actuators to cause the first extendable portion 530 to retract.

As shown, the first extendable portion 530 is coupled to a first portion 640 of the exterior portion 104 and the second extendable portion is coupled to a second portion 642 of the exterior portion 104. The first portion 640 includes the contact area 116. In the deployed configuration, the first extendable portion 530 causes the first portion 640 to pivot (e.g., to move toward the object 102) relative to a remainder of the exterior portion 104 that includes the second portion 642. Pivoting relative to the second portion 642 may cause the first portion 640 to move away from some of the internal structures of the vehicle 100, thereby allowing the first portion 640 to flex when the object 102 contacts the first portion 640 to absorb at least some of the force imparted to the contact area 116 by the object 102 upon contact. Similarly, the second extendable portion is configured to pivot the second portion 642 of the exterior portion 104 when in the deployed configuration.

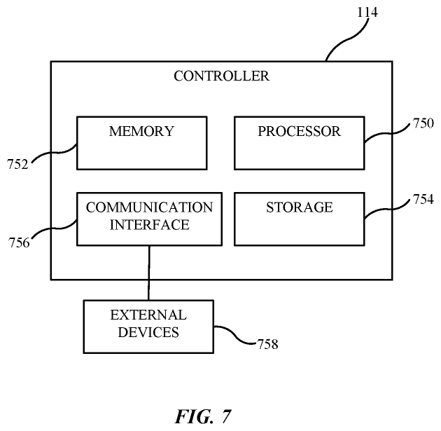

FIG. 7 is a diagram of the controller 114. The controller 114 may be used to implement the devices, systems, and methods disclosed herein. For example, the controller 114 may receive various signals from the sensor 112 and control operation of the first deployable portion 108 and the second deployable portion 110 based on the signals. In an example hardware configuration, the controller 114 generally includes a processor 750, a memory 752, a storage 754, and a communications interface 756. The processor 750 may be any suitable processor, such as a central processing unit, for executing computer instructions and performing operations described thereby. The memory 752 may be a volatile memory, such as random-access memory (RAM). The storage 754 may be a non-volatile storage device, such as a hard disk drive (HDD) or a solid-state drive (SSD). The storage 754 may form a computer readable medium that stores instructions (e.g., code) executed by the processor 750 to control operation of the first deployable portion 108 and the second deployable portion 110, for example, in the manners described above and below. The communications interface 756 is in communication with, for example, external devices 758 for sending and receiving various signals (e.g., control signals and/or notifications). The external devices 758 may include, for example, a mobile device (e.g., a mobile phone, tablet computer, laptop computer, etc.) associated with one or more occupants of the vehicle 100, a display system within the vehicle 100, a server associated with the manufacturer of the vehicle 100, etc.

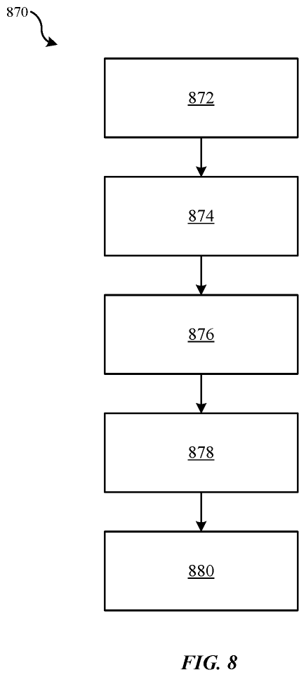

FIG. 8 is an illustration of a method 870 for the controller 114 taking an action before or during contact with the object 102. At operation 872, the object 102 is detected near the vehicle 100. For example, the sensor 112 sends a signal to the controller 114 that indicates that the object 102 is near the vehicle 100, and the signal may also indicate a relative distance between the object 102 and the vehicle 100.

At operation 874, contact with the object 102 is predicted. For example, the controller 114 may determine that the exterior portion 104 of the vehicle 100 will contact the object 102 based on a position of the object 102 and a velocity and/or acceleration of the vehicle 100. In addition, the controller 114 may predict one or more locations on the exterior portion 104 where the object 102 will contact the exterior portion 104. As described above, the object 102 may contact the exterior portion 104 at multiple locations (e.g., a primary contact area and a secondary contact area such as the contact area 116). The controller 114 may predict each of the contact areas based on the signals received from the sensor 112.

At operation 876, the controller 114 determines whether the object 102 is an object of interest. For example, the sensor 112 sends signals to the controller 114 regarding characteristics of the object 102 such as size, shape, movement, etc. The controller 114 evaluates the signals received and determines, using the machine learning model, whether the object 102 is an object of interest.

In some embodiments, after determining that the object 102 is an object of interest, the controller 114 may take one or more of the actions described above. For example, the controller 114 may deploy the first extendable portion 530 before the exterior portion 104 contacts the object 102. In implementations where the first extendable portion 530 is a reversible structure, deploying the first extendable portion 530 prior to contact does not affect the structural integrity and/or function of the vehicle 100. If contact with the object 102 is avoided, the first extendable portion 530 can be retracted without any negative consequences for the vehicle 100.

At operation 878, the controller 114 determines if contact with the object 102 has occurred. For example, the sensor 112 sends a signal to the controller 114 that indicates the object 102 has contacted the exterior portion 104. As described, the signal may include an indication that the speed and/or acceleration of the vehicle 100 has decreased rapidly. The signal may also include an indication that a force was imparted to the exterior portion 104 by the object 102.

At operation 880, an action is taken. For example, the controller 114 may cause the first inflatable portion 320 to inflate to cover the first portion 424. The controller 114 may also cause the first extendable portion 530 to extend to cause the first portion 640 to pivot relative to the second portion 642. In some embodiments, the action also includes causing the first inflatable portion 320 or the first extendable portion 530 to retract.

As described above, one aspect of the present technology is the gathering and use of data available from various sources for use in operating and controlling the vehicle 100 as described herein. As an example, such data may identify the user and include user-specific settings or preferences. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, a user profile may be established that stores user preference related information that allows adjustment of the operation of the vehicle 100 according to the user preferences. Accordingly, use of such personal information data enhances the user's experience.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of storing a user profile for operating the vehicle 100, the present technology can be configured to allow users to select to “opt in” or “opt out” of participation in the collection of personal information data during registration for services or anytime thereafter. In another example, users can select not to provide data regarding usage of specific applications. In yet another example, users can select to limit the length of time that application usage data is maintained or entirely prohibit the development of an application usage profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, user preference information may be determined each time the vehicle 100 is used, such as by entering such information each time the vehicle 100 is used, and without subsequently storing the information or associating the information with the particular user.

What is claimed is:

1. A vehicle, comprising:
an internal support;
an exterior portion coupled to the internal support;
a deployable portion coupled to the exterior portion and including a stored configuration and a deployed configuration; and
a sensor configured to output a signal that indicates contact between the exterior portion and an object has occurred,
wherein the contact between the exterior portion and the object is predicted prior to the contact, and the deployable portion is configured to transition between the stored configuration and the deployed configuration based on the prediction and the signal.

2. The vehicle of claim 1, wherein the sensor is configured to output a signal that indicates a height of the object, and the deployable portion is configured to transition between the stored configuration and the deployed configuration based on the height of the object.

3. The vehicle of claim 2, wherein the deployable portion includes an inflatable portion, and the inflatable portion is configured to inflate based on the height of the object.

4. The vehicle of claim 2, wherein the deployable portion includes an extendable portion, and the extendable portion is configured to extend based on the height of the object.

5. The vehicle of claim 1, wherein the sensor is configured to output a signal that indicates an contact area located on the exterior portion, and the deployable portion is configured to transition between the stored configuration and the deployed configuration based on the contact area.

6. The vehicle of claim 5, wherein the deployable portion includes an inflatable portion, and the inflatable portion is configured to inflate based on the contact area.

7. The vehicle of claim 5, wherein the deployable portion includes an extendable portion, and the extendable portion is configured to extend based on the contact area.

8. The vehicle of claim 1, wherein, prior to the contact, the object is determined to be an object of interest, and the deployable portion is configured to transition between the stored configuration and the deployed configuration based on the determination and the signal.

9. The vehicle of claim 1, wherein the signal is a force signal.

10. A vehicle, comprising:
an internal support;
an exterior portion coupled to the internal support; and
a deployable portion coupled to the exterior portion and including a stored configuration and a deployed configuration,
wherein the deployable portion is configured to be in the deployed configuration before contact occurs between the exterior portion and an object.

11. The vehicle of claim 10, wherein the deployable portion is configured to transition between the stored configuration and the deployed configuration based on the contact occurring at a contact area located on the exterior portion.

12. The vehicle of claim 11, wherein the deployable portion includes a reversible inflatable portion, and the reversible inflatable portion is configured to inflate to transition between the stored configuration and the deployed configuration, wherein in the deployed configuration the reversible inflatable portion covers a portion of the exterior portion that includes the contact area and leaves a remainder of the exterior portion uncovered.

13. The vehicle of claim 12, wherein the reversible inflatable portion is deflated to transition between the deployed configuration and the stored configuration.

14. The vehicle of claim 11, wherein the deployable portion includes a reversible extendable portion, and the reversible extendable portion is configured to extend to transition between the stored configuration and the deployed configuration, wherein in the deployed configuration the reversible extendable portion causes a portion of the exterior portion that includes the contact area to pivot relative to a remainder of the exterior portion.

15. The vehicle of claim 14, wherein the reversible extendable portion is retracted to transition between the deployed configuration and the stored configuration.

16. The vehicle of claim 11, wherein the deployable portion is configured to be selectively deployed based on the contact area.

17. A contact detection system, comprising:
a first deployable portion coupled to an exterior portion of a vehicle; and
a second deployable portion coupled to the exterior portion of the vehicle, wherein the first deployable portion and the second deployable portion are independently movable from a stored configuration to a deployed configuration,
wherein either the first deployable portion or the second deployable portion are selected for deployment and the selected one of the first deployable portion or the second deployable portion is deployed.

18. The contact detection system of claim 17 wherein the first deployable portion includes a first inflatable portion and the second deployable portion includes a second inflatable portion, wherein the first inflatable portion is configured to cover a first portion of the exterior portion when in the deployed configuration, wherein the second inflatable portion is configured to cover a second portion of the exterior portion when in the deployed configuration.

19. The contact detection system of claim 17, wherein the first deployable portion includes a first extendable portion and the second deployable portion includes a second extendable portion, wherein the first extendable portion is configured to pivot a first portion of the exterior portion when in the deployed configuration, wherein the second extendable portion is configured to pivot a second portion of the exterior portion when in the deployed configuration.

20. The contact detection system of claim 17, wherein the first deployable portion or the second deployable portion is configured to transition between the stored configuration and the deployed configuration based on a contact area on the exterior portion where the exterior portion contacts an object, wherein moving from the stored configuration to the deployed configuration occurs after the exterior portion contacts the object.

21. The contact detection system of claim 17, wherein the first deployable portion or the second deployable portion is configured to transition between the stored configuration and the deployed configuration based on a contact area on the exterior portion where the exterior portion will contact an object, wherein moving from the stored configuration to the deployed configuration occurs before the exterior portion contacts the object.
